(19) United States
(12) Patent Application Publication
(10) Pub. No.: US 2003/0059355 A1
(43) Pub. Date: Mar. 27, 2003

(54) Method for generating carbon dioxide

(76) Inventor: Shane Chen, Camas, WA (US)

Correspondence Address: Bruce W. DeKock/Chernoff,, Vilhauer, McClung & Stenzel, LLP, Suite 1600, 601 S.W. Second Avenue, Portland, OR, 97204, US

(21) Appl. No.: 09/922,021

(22) Filed: Aug. 2, 2001

(51) Int. Cl. B01F 1/00

(52) U.S. Cl. 422/224

(57) ABSTRACT

A method and apparatus provides sustained, controlled levels of carbon dioxide to a plant, or alternatively elevates the level of carbon dioxide in a plant culturing environment.

### BACKGROUND OF THE INVENTION

The invention relates to methods and devices for generating carbon dioxide for a sustained length of time for a variety of applications, including providing a controlled carbon dioxide gas content for measuring photosynthesis or other plant activity, or providing elevated carbon dioxide levels for use in a greenhouse.

There are a variety of applications in which it is desired to provide controlled levels of carbon dioxide over a sustained period of time in connection with the growing of plants, as well as the measurement of various plant activities, such as photosynthesis. In a typical application in which it is desired to measure the rate of photosynthesis of a plant, an input gas mixture containing a measured content of carbon dioxide is directed into a leaf chamber, which may enclose the surface of a leaf of a plant. Typically, the controlled level of carbon dioxide varies from near 0 to up to 4000 ppm. The carbon dioxide content of the gas discharged from the leaf chamber is then measured. By comparing the amount of carbon dioxide exiting the cell with the amount of carbon dioxide in the input gas mixture entering the cell, various plant functions may be measured.

One conventional method for providing a controlled level of carbon dioxide in the input gas mixture involves the use of a cartridge containing liquid carbon dioxide. Air is first directed through a carbon dioxide scrubber to remove substantially all of the carbon dioxide from the air. Pure gaseous carbon dioxide is released from the cartridge and a small amount of pure carbon dioxide gas is then mixed with the scrubbed air to result in a controlled level of carbon dioxide in the input gas mixture. There are two major problems with this method of providing a gas having a controlled carbon dioxide level. First, the carbon dioxide cartridges present a hazard due to the high pressure under which the liquid carbon dioxide is stored. Such cartridges must be carefully shipped, stored and used. Serious injury may result if the cartridge is damaged. This leads to the second problem, which is that providing carbon dioxide cartridges is very expensive due to high shipping costs. Since it is often desired to provide a controlled carbon dioxide level for sustained periods of time, it is often necessary to periodically replace the cartridges, entailing additional expense.

Another application where it is desired to control the level of carbon dioxide is the cultivation of plants. For example, it is often desired to increase the level of carbon dioxide present in a greenhouse. The conventional method of increasing the amount of carbon dioxide present in a greenhouse is through combustion of propane or natural gas. The level of carbon dioxide present in the atmosphere is about 360 ppm. Typically, it is only desired to increase the amount of carbon dioxide present in the greenhouse to about 2000 ppm. The disadvantages attendant to use of combustion to increase the level of carbon dioxide present in a culturing environment, such as a greenhouse, are the safety hazards associated with combustion itself, namely an open flame within the greenhouse, generation of heat, lack of portability, and the cost associated with burning the propane or natural gas.

Accordingly, what is desired is a method for generating controlled quantities of carbon dioxide that is safe to use and relatively inexpensive. These and other needs will become apparent from the description which follows.

### SUMMARY OF THE INVENTION

The invention provides a method and apparatus for providing sustained, controlled levels of carbon dioxide to a plant, and for elevating the level of carbon dioxide in a plant culturing environment.

In a first aspect of the invention, an apparatus provides for a controlled level of carbon dioxide to a plant. A chamber is adapted to enclose at least a portion of the plant. The apparatus includes a gas source capable of providing a first gas substantially free of carbon dioxide. The apparatus also includes a carbon dioxide generator. The generator is in fluid communication with the chamber and the gas source. The generator comprises a vessel containing an aqueous solution of at least one of hydrogen carbonate ions and carbonate ions.

In a second aspect of the invention, a method provides a controlled level of carbon dioxide to a plant. First, at least a portion of the plant is enclosed by a chamber. Next, a gas source is provided which is capable of providing a first gas substantially free of carbon dioxide. A carbon dioxide generator is then provided. The generator is in fluid communication with the chamber of the gas source. The generator comprises a vessel containing an aqueous solution of at least one of hydrogen carbonate ions and carbonate ions. Carbon dioxide is then produced from the generator. The carbon dioxide is mixed with the first gas to produce a gas mixture having a level of carbon dioxide. The gas mixture is then flowed into the chamber.

These aspects of the invention have significant advantages over the prior method of providing a sustained, controlled amount of carbon dioxide to a plant. Carbon dioxide is produced from an aqueous solution containing hydrogen carbonate ions and/or carbonate ions. These ions may be formed in a solution by simply adding inexpensive, common materials such as sodium bicarbonate to an aqueous solution. The carbon dioxide generator is not under pressure, and therefore does not present a safety risk. Moreover, the common materials used to create the aqueous solution from which the carbon dioxide is generated, such as sodium bicarbonate, are inexpensive and easy to transport.

In a third aspect of the invention, a method is provided for elevating the level of carbon dioxide in a plant culturing environment. First, an enclosure is formed to surround a plurality of plants. Next, a carbon dioxide generator is provided which is in fluid communication with the enclosure. The generator comprises a vessel containing an aqueous solution of at least one of hydrogen carbonate ions and carbonate ions. Carbon dioxide is then produced from the generator in a sufficient quantity so as to elevate the level of carbon dioxide in the enclosure above the ambient level.

This aspect of the invention has the advantage of being much safer and cheaper than the conventional method of elevating carbon dioxide levels in a culturing environment such as a greenhouse. The invention does not utilize an open flame, and thus reduces risks associated with combustion, and also does not generate heat within the greenhouse. The generator is easily moved from one location to another and does not require the installation of gas pipelines or burners. In addition, an inexpensive source of carbonate ions may be used, such as baking soda, rather than more expensive natural gas or propane.

In another aspect of the invention, a method is provided for elevating the level of carbon dioxide to a plant culturing environment. The method comprises providing a carbon dioxide generator comprising a vessel containing an aqueous solution of at least one of hydrogen carbonate ions and carbonate ions. The solution is agitated to produce carbon dioxide so as to generate in the plant culturing environment a carbon dioxide level that is above ambient conditions.

In yet another aspect of the invention, an apparatus provides a controlled level of carbon dioxide to a plant. The apparatus comprises a vessel containing an aqueous solution of at least one of hydrogen carbonate ions and carbonate ions. The vessel has an agitation section. An agitator is adapted to agitate the solution A water source is in fluid communication with the vessel for supplying water to the vessel. The vessel has a drain to allow the aqueous solution to flow out of the vessel.

In yet another aspect of the invention an apparatus for generating carbon dioxide is provided. The generator comprises a chamber and a carbon dioxide generator in fluid communication with the chamber. The generator comprises a first section containing an aqueous solution of at least one of hydrogen carbonate ions and carbonate ions and a second section containing an acidic solution. A wick is disposed between the first section and the second section.

The foregoing and other objectives, features, and advantages of the invention will be more readily understood upon consideration of the following detailed description of the invention, taken in conjunction with the accompanying drawings.

### BRIEF DESCRIPTION OF DRAWINGS

FIG. 1 is a schematic diagram of a measurement apparatus used to conduct photosynthesis measurements of a plant.

FIG. 2 is a schematic diagram of an exemplary carbon dioxide generator for providing a controlled level of carbon dioxide.

FIG. 3 is a schematic diagram of an alternative embodiment of a carbon dioxide generator.

FIG. 4 is a schematic diagram of another alternative embodiment of a carbon dioxide generator.

FIG. 5 is a schematic diagram of another alternative embodiment of a carbon dioxide generator.

FIG. 6 is a schematic diagram of another alternative embodiment of a carbon dioxide generator.

FIG. 7 is a schematic diagram of another alternative embodiment of a carbon dioxide generator.

FIG. 8 is a schematic diagram of another alternative embodiment of a carbon dioxide generator.

FIG. 9a is a schematic diagram of another alternative embodiment of a carbon dioxide generator.

FIG. 9b is a schematic diagram of another alternative embodiment of a carbon dioxide generator.

FIG. 10 is a schematic diagram of one embodiment of a carbon dioxide generator connected to a gas source and the input of a measurement device.

FIG. 11 is a schematic diagram of an alternative embodiment of a carbon dioxide generator connected to a gas source and the input of a measurement device.

FIG. 12 is a flowchart of a method for providing an elevated carbon dioxide level in a plant culturing environment.

FIG. 13 is an exemplary embodiment of a carbon dioxide generator used to elevate the carbon dioxide content of a greenhouse.

### DETAILED DESCRIPTION OF THE PREFERRED EMBODIMENTS

The present invention provides a controlled, sustained level of carbon dioxide gas for a variety of applications, particularly in connection with the measurement of various plant activities, and for elevating the carbon dioxide level of a plant culturing environment.

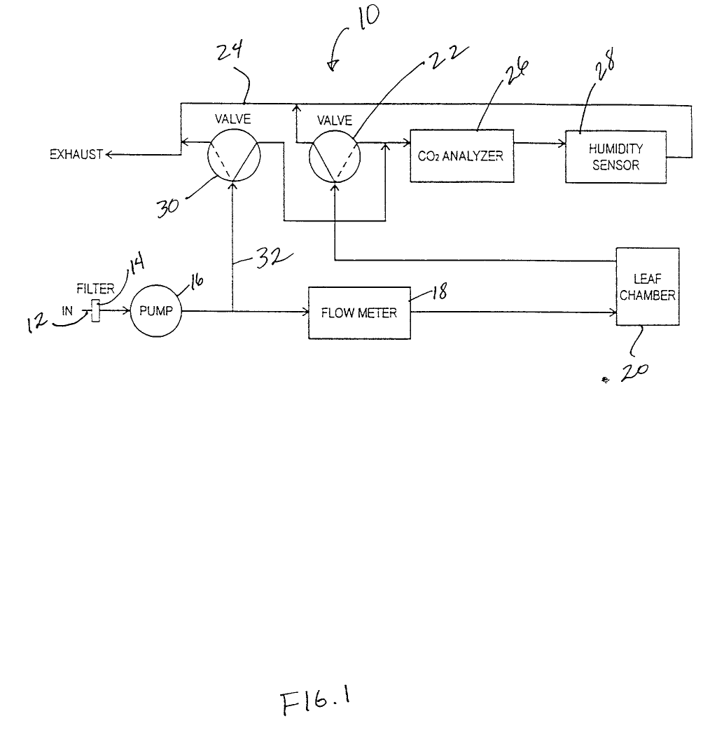

FIG. 1 shows an exemplary embodiment of a device 10 used to measure plant activity, and more particularly to measure photosynthesis. In this device, an inlet 12 is provided for a gas mixture having a controlled level of carbon dioxide. The gas mixture having the controlled level of carbon dioxide enters through the inlet 12 and passes through an air filter 14 to remove dust or particulates and then through a pump 16. The gas mixture may then flow through a flowmeter 18, such as a mass flowmeter, to monitor the airflow rate.

The gas mixture then passes through a chamber 20, which is simply a sealed enclosure which encloses at least a portion of the plant. The chamber 20 may be a conventional leaf chamber which encloses a leaf or branch, or which is applied to and encloses only a portion of the surface of a leaf. The chamber may also be a growth chamber which encloses one or more plants. Any conventional leaf chamber or growth chamber may be used.

The gas exiting the chamber 20 is then directed to a valve 22, which directs the exiting gas either to an exhaust line 24 or to a CO₂ analyzer 26. The CO₂ analyzer 26 measures the carbon dioxide content of the gas exiting the chamber 20. A humidity sensor 28 may also be provided to allow measurement of relative humidity of the gas exiting the leaf chamber 20. In addition, the device includes a valve 30 for a control line 32, so that the gas mixture entering the device 10 may be directed toward either the exhaust line 24 or the carbon dioxide analyzer 26. By comparing the difference between the carbon dioxide level of the input gas mixture and the gas exiting the chamber 20, the rate of photosynthesis in the plant may be determined.

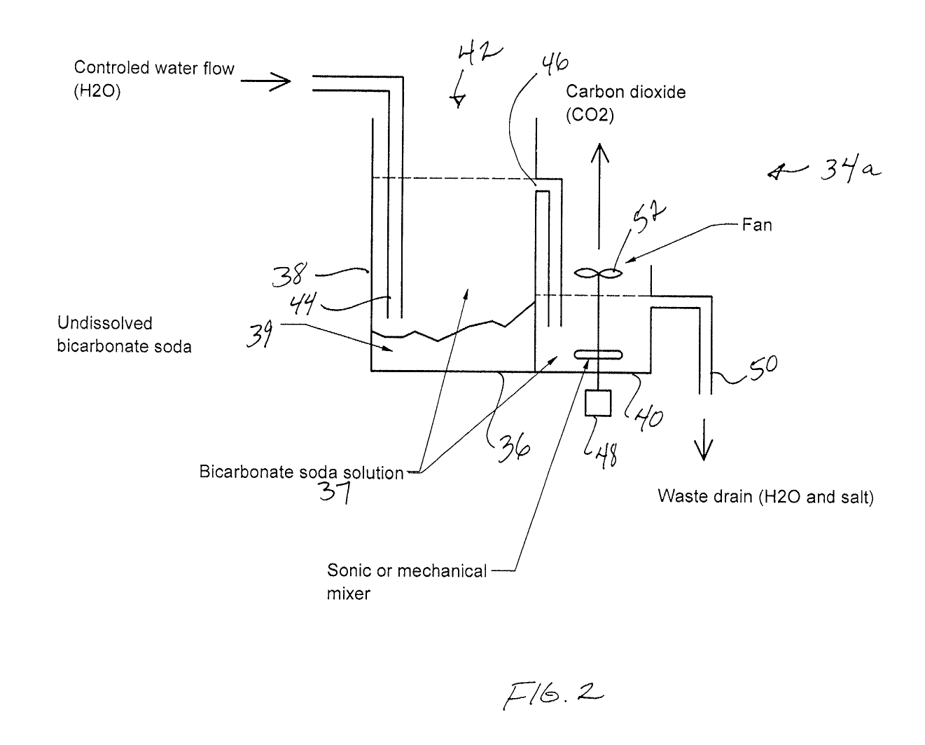

The device 10 is connected to a carbon dioxide generator 34 which provides a small, controlled level of carbon dioxide. FIG. 2 shows an exemplary embodiment of a carbon dioxide generator 34a for providing a controlled level of carbon dioxide. The generator 34a has a vessel 36 containing an aqueous solution 37. The aqueous solution contains hydrogen carbonate ions (HCO₃⁻) and/or carbonate ions (CO₃²⁻) to supply a source of carbon dioxide gas. For example, such a solution may be formed by preparing a solution of sodium bicarbonate, or baking soda, (NaHCO₃). Preferably, a saturated solution is formed such that solid, undissolved sodium bicarbonate 39 is present in the aqueous solution. Alternatively, other salts of carbonate ions may be used, such as sodium carbonate, sodium sesquicarbonate, potassium carbonate, or other suitable salts. Carbon dioxide gas is formed by simply agitating the solution. Surprisingly, the inventor has found that a small amount of carbon dioxide gas may be produced merely by sufficiently agitating an aqueous solution containing HCO₃⁻ and CO₃²⁻ ions, and that the amount of carbon dioxide gas produced may be controlled by simply controlling the degree of agitation.

In the embodiment shown in FIG. 2, the vessel is divided into two parts, namely a loading section 38 and an agitation section 40. The loading section 38 has an open top 42 and allows solid carbonate salt, such as baking soda, to be poured into the loading section 38 to form a saturated solution. This forms an aqueous solution containing HCO₃⁻ and CO₃²⁻ ions. The loading section 38 has a water inlet 44 and a water outlet 46. Water is pumped into the loading section 38 through the water inlet 44 until the water level reaches the level of the water outlet 46. The water outlet 46 connects the loading section with the agitation section 40. The solution exits through the water outlet 46 into the agitation section 40, which contains an agitator 48. The agitator 48 is used to agitate the solution, which causes the HCO₃⁻ and CO₃²⁻ ions in the solution to form carbon dioxide gas. The agitator 48 may be a mechanical mixer, a sonic mixer, or any other device that may be used to agitate or mix the solution. The agitation section 40 also has a drain 50 which allows the depleted solution to exit from the agitation section 40, as fresh saturated solution is pumped into the agitation section 40 from the loading section 38. In the embodiment shown in FIG. 2, an optional fan 52 is used in order to aid in removal of carbon dioxide from the vessel.

The amount of carbon dioxide gas generated may be controlled by the rate at which the water flows through the loading and agitation sections 38 and 40, and the degree of agitation provided by the agitator 48. The rate of water flow and degree of agitation may be chosen such that most of the baking soda (or other carbonate salt) is used to generate carbon dioxide, and the remaining products, namely water and salt, are drained out through the waste drain 50.

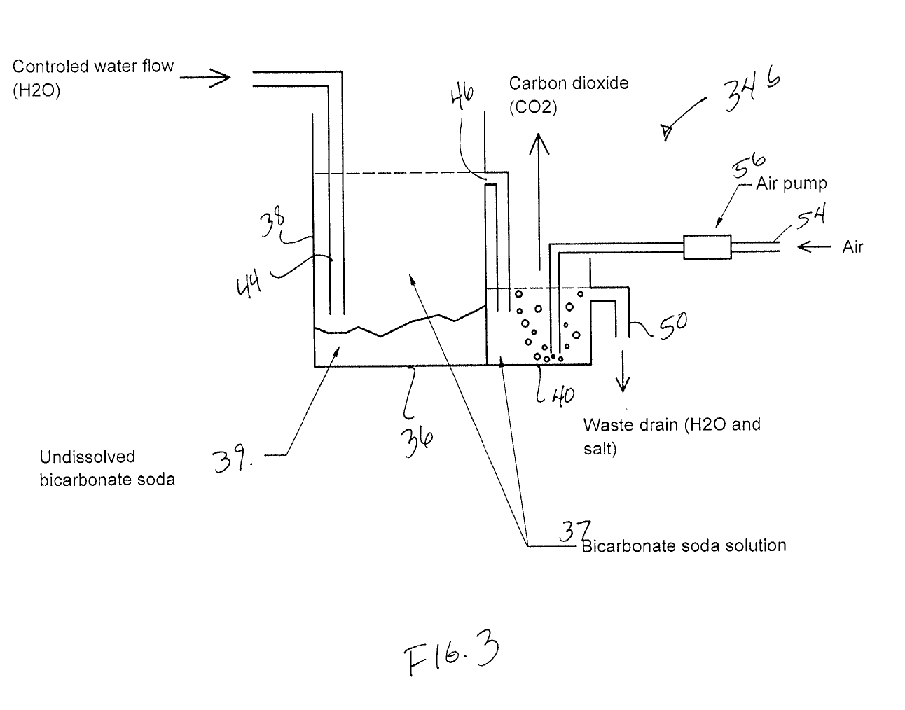

An alternative generator 34b utilizing a different method for agitating the solution is shown in FIG. 3, in which the like numbered elements are the same as those shown in FIG. 2, with the exception that in lieu of a mechanical agitator, air is pumped into the agitation section 38 in order to agitate the solution. FIG. 3 shows an air inlet 54, to which is connected an air pump. The air pump 56 forces air or gas into the agitation section 40 so as to agitate the solution 37 and cause carbon dioxide gas to be formed. An optional bubble generating device (not shown), such as a screen, air filter, glass wool, or other device, may be used in order to control the size of the air bubbles released into the solution 37. Preferably, the device distributes the bubbles throughout the solution. This embodiment has the advantage that a fan is not needed in order to aid the release of CO₂ from the vessel 36.

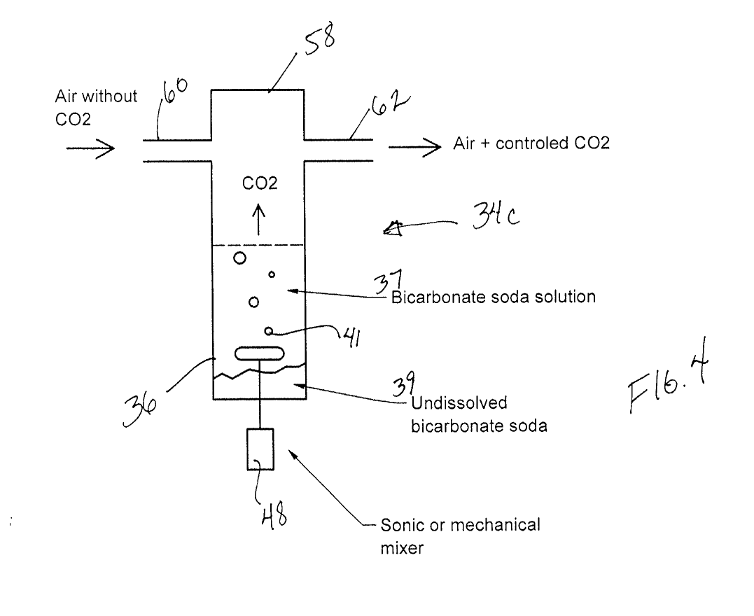

FIG. 4 shows yet another embodiment of a generator 34c in which the agitator 48 alone controls the rate of release of carbon dioxide. In this embodiment, a vessel 36 has a solution that contains HCO₃⁻ and CO₃²⁻ ions. For example, a sufficient quantity of baking soda may be added into the aqueous solution so as to provide HCO₃⁻ and CO₃²⁻. An agitator 48, such as a sonic agitator or mechanical mixer, may be used to agitate the solution. The upper portion 58 of the vessel is in fluid communication with a gas inlet 60, and a gas outlet 62. Connected to the gas inlet is a gas source (not shown).

When the generator 34c is used with a measurement device 10, the gas source is capable of providing gas at a controlled rate that is substantially free of carbon dioxide. By substantially free is meant that the input gas from the gas source contains less than 50 ppm, and preferably less than 5 ppm of carbon dioxide. For example, the gas inlet may be connected to an air pump and a carbon dioxide scrubber, which causes air to be pumped through a carbon dioxide scrubber to remove carbon dioxide before the air enters the vessel. Alternatively, the gas source may be a tank containing nitrogen or similar gas. The resulting gas mixture exiting the vessel contains the carbon dioxide gas released from the solution in the vessel mixed with the input gas. The amount of carbon dioxide gas contained in the exiting gas mixture is controlled by the degree of agitation caused by the agitator and rate of flow of the input gas. Thus, where the agitator is a stirring mechanism, the level of carbon dioxide in the exiting gas mixture may be controlled by controlling the rate of stirring.

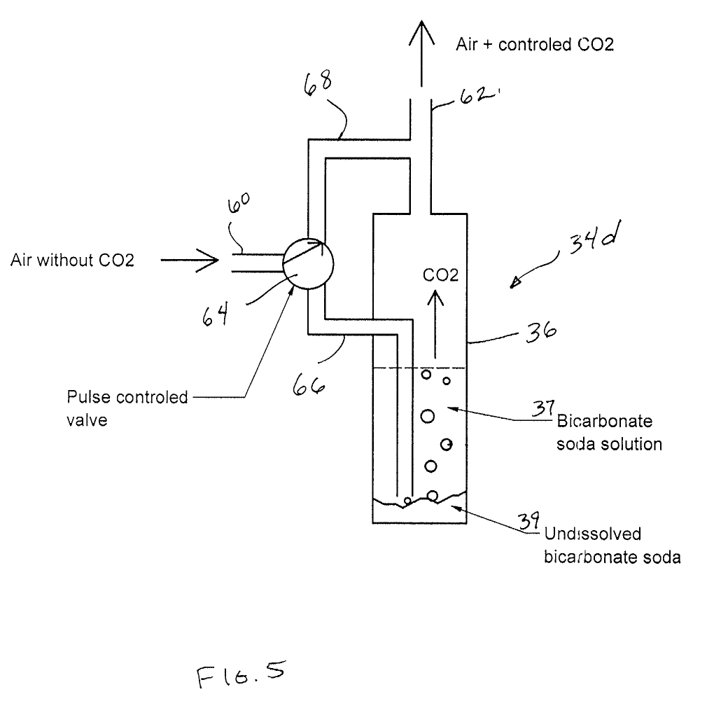

FIG. 5 shows yet another alternative embodiment in which a pulse controlled valve 64 is used to control the amount of carbon dioxide in the gas mixture exiting from the generator 34d. The generator 34d has a gas inlet 60 which provides a source of gas that is substantially free from carbon dioxide. For example, the gas may be air that is pumped through a carbon dioxide scrubber. The pulse controlled valve 64 selectively directs air into two different pathways 66 and 68. Both pathways 66 and 68 are in fluid communication with the vessel 36. The vessel 36 contains an aqueous solution 37 containing HCO₃⁻ and CO₃²⁻ ions. The first pathway 66 connects the pulse controlled valve to the aqueous solution. This causes the aqueous solution to be agitated so as to release carbon dioxide gas. The second pathway 68 is connected to the gas outlet 62. By controlling the pulse controlled valve 64 so as to direct the desired amount of input gas into either the first pathway 66 or second pathway 68, the amount of carbon dioxide contained in the gas mixture exiting the vessel 36 through the gas outlet 62 may be controlled. For example, in order to achieve high levels of carbon dioxide in the exiting gas mixture, the pulse controlled valve 64 would be used to distribute more input gas from the gas source into the first pathway 66, while to decrease the amount of carbon dioxide gas in the gas mixture, more input gas would be directed toward the second pathway 68.

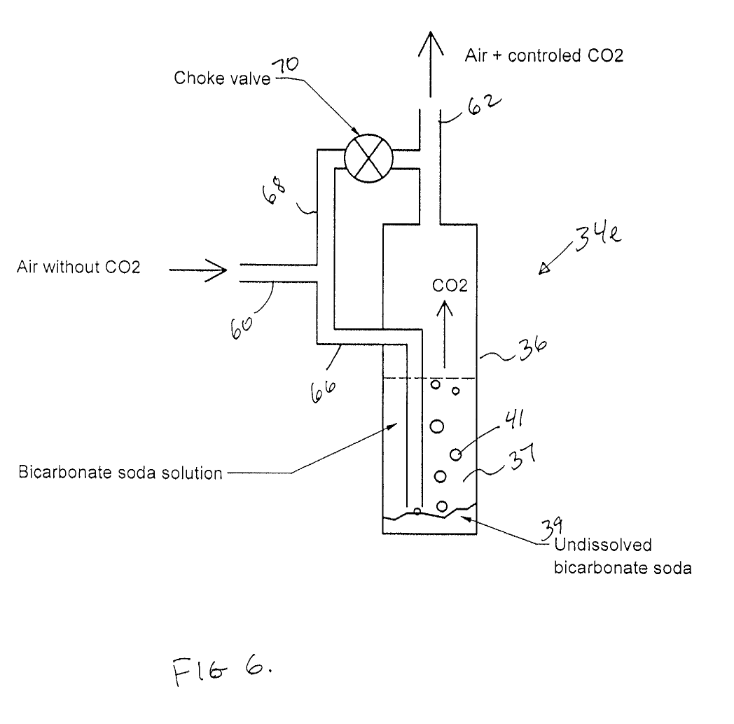

FIG. 6 shows yet another example of a generator 34e. In this embodiment, a choke valve 70 is used, rather than a pulse controlled valve, to control the amount of carbon dioxide gas generated. The valve 70 may be controlled in order to selectively direct different amounts of input gas through the two different pathways 66 and 68. For example, when the choke valve 70 is completely open, almost all of the input gas will pass through the valve 70 and exit through the gas outlet 62 to generate a minimum amount of carbon dioxide in the exiting gas mixture. When the choke valve 70 is completely closed, all of the input gas will be forced into the first pathway 66 and into the aqueous solution 37. This causes maximum generation of carbon dioxide gas within the vessel 36, and thus maximizes the amount of carbon dioxide in the gas mixture exiting the vessel 36 through the gas outlet 62.

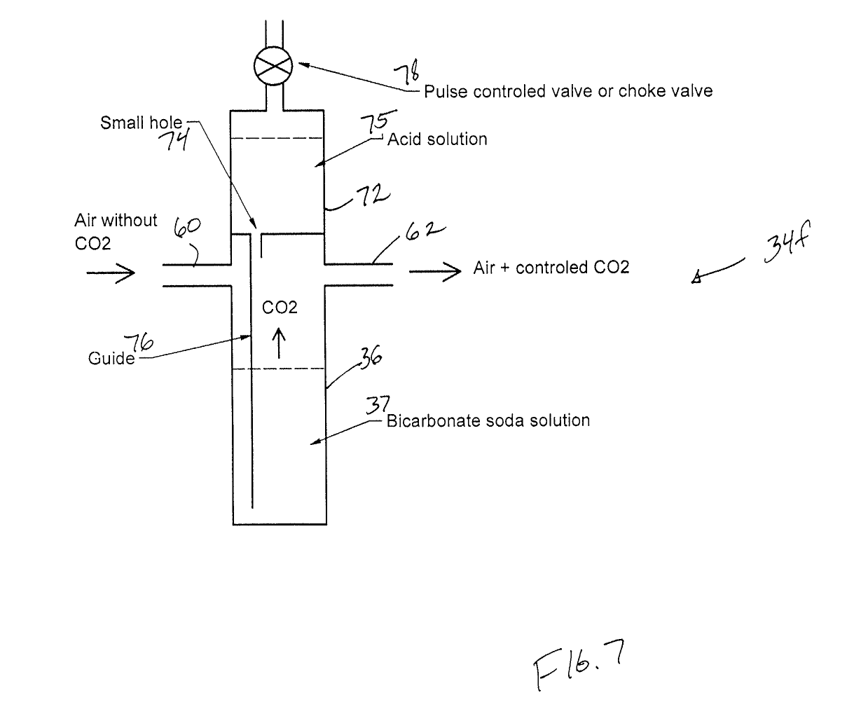

As yet another alternative embodiment of a generator, the rate of carbon dioxide generation is controlled by addition of a small amount of acid to the HCO₃⁻ and CO₃²⁻ solution 37. For example, referring to FIG. 7, the generator 34f has a vessel 36 containing a solution of sodium bicarbonate. The vessel 36 has a gas inlet 60 to supply a source of input gas that is substantially free from carbon dioxide. The vessel 36 is also in fluid communication with a gas outlet 62. At the upper end of the vessel 36 is a chamber 72 containing an acidic solution 75. Any conventional acidic solution may be used, including strong acids such as HCl and H₂SO₄ and weak acids such as citric acid or acetic acid. The chamber 72 has a drain port 74 at the lower portion of the chamber in communication with the vessel 36. An optional guide 76, such as a glass rod or other similar device is used to allow the acidic solution 75 exiting the drain port 74 at the lower portion of the upper chamber 72 to overcome surface tension and flow into the sodium bicarbonate solution 37 in the vessel 36. This provides a continuous rate of carbon dioxide reaction, rather than pulsed generation which would result from periodic drops of an acidic solution. By controlling the rate of addition of an acidic solution 75 to the sodium bicarbonate solution 37, a controlled amount of carbon dioxide may be generated. The rate at which the acidic solution is added into the sodium bicarbonate solution may be controlled through any conventional mechanism. For example, a valve 78 such as a pulse-controlled valve or choke valve may be used to control the rate at which air or gas is allowed to enter the chamber, thus controlling the rate at which the acidic solution exits through the drain port, thus controlling the rate of production of carbon dioxide. Alternatively, a valve may be placed between the chamber 72 and solution 37 to control the flow rate of the acidic solution 75.

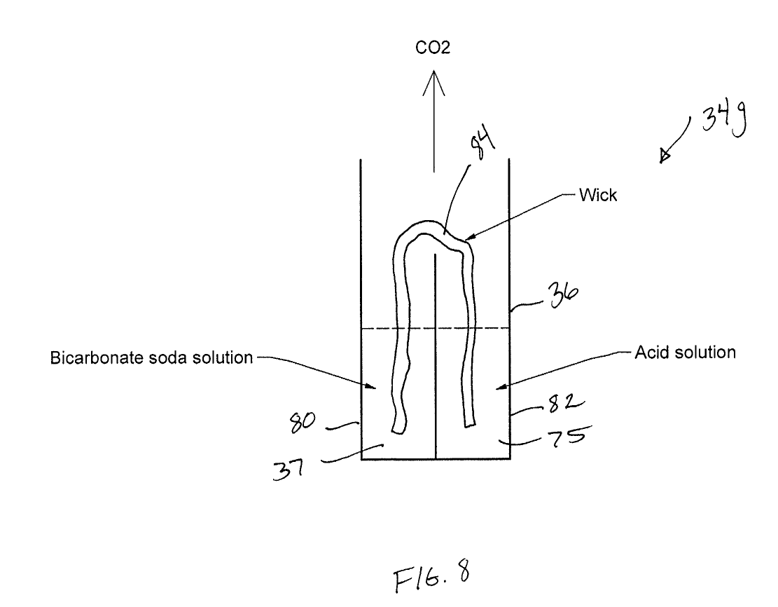

Yet another embodiment of a generator 34g which provides for the controlled reaction of an acidic solution 75 with a solution 37 containing HCO₃⁻ and CO₃²⁻ ions is shown in FIG. 8, in which the vessel 36 is divided into two portions 80 and 82. The first portion 80 contains the sodium bicarbonate solution 37. The second portion 82 contains an acidic solution 75. A wick 84 is disposed between the two solutions. The wick 84 causes the acidic solution 75 and the sodium bicarbonate solution 37 to be absorbed and to come into contact with one another and react, thus generating carbon dioxide. The rate at which carbon dioxide is produced may be controlled by choosing wicks of different properties so as to affect the rate at which the solutions are absorbed into the wick. Thus, the thickness or length of the wick may be altered, or the materials used to form the wick may be varied. The height of the wick above the solution level may also be varied in order to vary the rate of carbon dioxide generation.

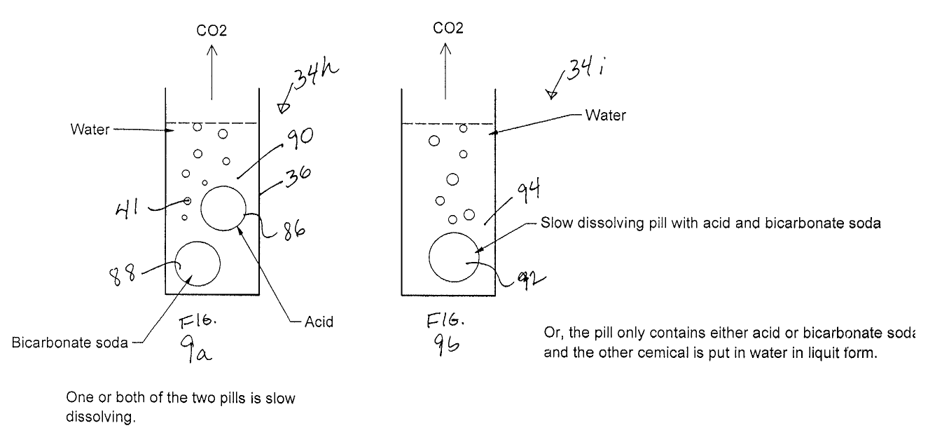

FIG. 9a shows yet another embodiment of a generator 34h which provides for controlling the reaction rate of HCO₃− and CO₃²⁻ ions and an acid. In the embodiment shown in FIG. 9a, both the acid and the sodium bicarbonate (or other carbonate salt) are in the form of controlled release devices 86 and 88 which control the rate of release of the acid and sodium bicarbonate into an aqueous solution 90. For example, the acid and the sodium bicarbonate (or other carbonate salt) may both be in the form of an erodible device or matrix, which slowly erodes, dissolves, or otherwise breaks apart to release the acid and sodium bicarbonate at a controlled rate into the solution. For example, the acid and/or sodium bicarbonate may be suspended in a polymer which slowly dissolves, swells, or erodes when placed in an aqueous solution. The acid and sodium bicarbonate react with one another as they are released from the devices 86 and 88, or as water enters the devices, to generate carbon dioxide gas 41.

Alternatively, as shown in FIG. 9b, only one of the sodium bicarbonate (or other carbonate salt) or acidic material may be in the form of a controlled release device 92. This device may then be placed in a solution 94, which may be either acidic (in the case of a device containing sodium bicarbonate) or an aqueous solution containing carbonate ions, in which case the controlled release device contains the acid. In either case, the controlled release device slowly erodes, dissolves or breaks apart so as to release the material into the solution, thus generating carbon dioxide. As yet another alternative, both the acid and the carbonate salt may be in the controlled release device.

The carbon dioxide generators described herein may be used in a variety of applications as described above. For example, such carbon dioxide generators may be used in conjunction with test and measurement devices used to analyze photosynthesis rates, or other activity of plants. The present inventor estimates that approximately one gram of baking soda may be used to produce about 100 liters of air with a carbon dioxide concentration of about 2,667 ppm. While a particular measurement device 10 has been shown for use in connection with measuring photosynthesis by measuring the carbon dioxide level of the gas exiting the leaf chamber, the present invention may be used with any measurement device in which a controlled carbon dioxide level is supplied to a plant.

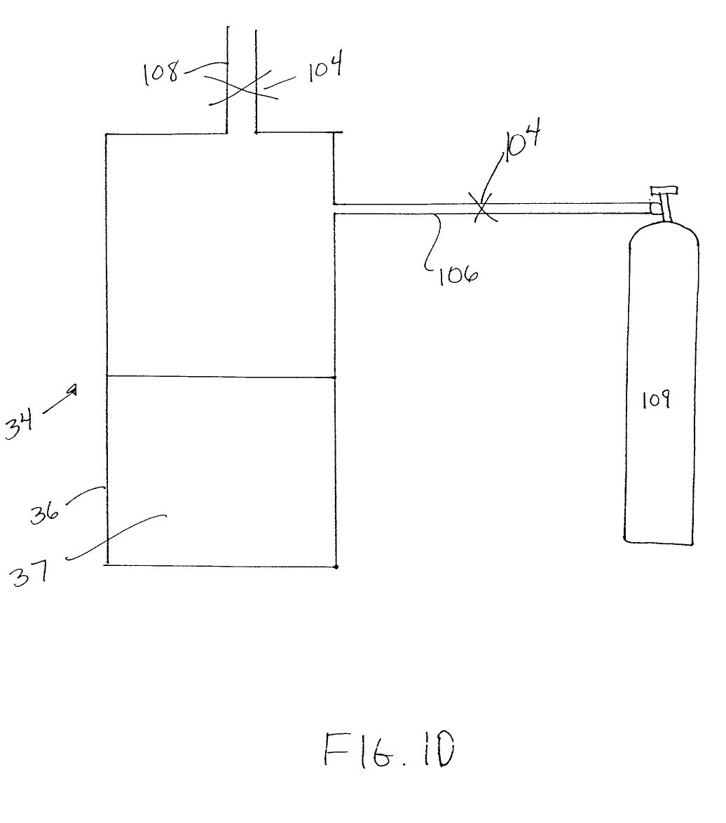

When the generator is used with a measurement device, the carbon dioxide generator and input gas source are in fluid communication with one another and connected so that the gas from the gas source and the carbon dioxide may be mixed to a desired level. Any conventional method may be used to connect the gas source to the carbon dioxide generator and to mix the carbon dioxide with the gas from the gas source. An exemplary embodiment is shown in FIG. 10. In this embodiment, a first gas line 106 connects the generator to the input gas source, which in this case is a gas tank 109. A second gas line 108 connects the generator 34 to the gas inlet 12 of the measurement device 10. Valves 104 or other regulators may be used to control the flow of gas from the gas source into the generator 34, and from the generator 34 out toward the gas inlet 12. This embodiment is particularly suited for generators which produce carbon dioxide by merely agitating the solution. While not wishing to be bound by a particular theory, the inventor believes that it is necessary to remove the carbon dioxide gas from the vessel in order to allow additional carbon dioxide to be produced from the aqueous solution. Flowing gas that is substantially free from carbon dioxide through the vessel allows carbon dioxide gas shifts the equilibrium of the system toward production of carbon dioxide.

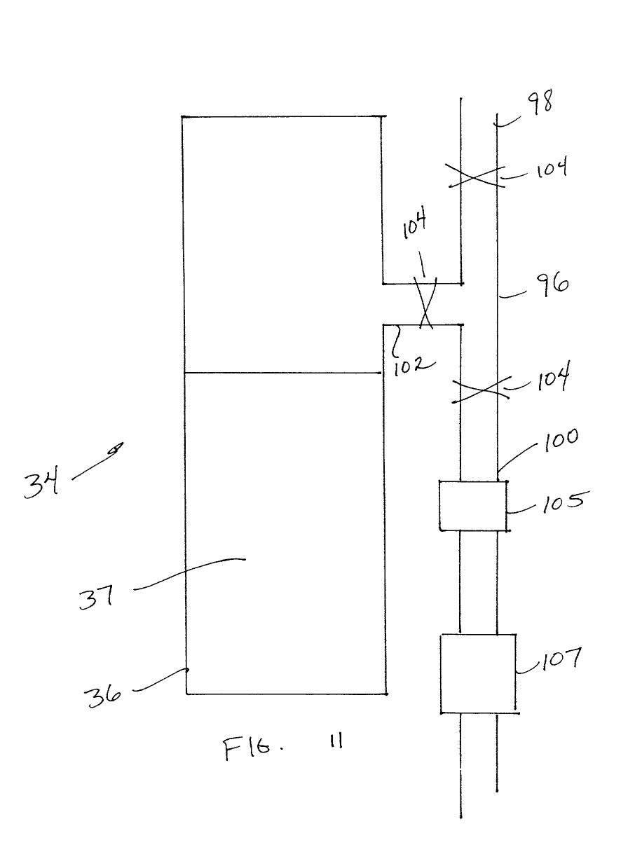

FIG. 11 shows an alternative embodiment which may be used in connection with the embodiments of FIGS. 7-9. A gas line 96 is connected at one end 98 to the gas inlet 12 of the measurement device 10, while the other end 100 is connected to the input gas source, which consists of an air scrubber 105 connected in line with an air pump 107. A single line 102 is used to connect the carbon dioxide generator 34 with the gas line 96. One or more valves 104 or other regulators may be used to control the flow rate of the input gas from the input gas source, the flow of carbon dioxide from the generator 34, and the flow of the resulting gas mixture into the gas inlet 12.

Alternatively, the carbon dioxide generators may be used to generate carbon dioxide for a greenhouse or other plant culturing applications. In such applications, it is only necessary to generate the desired amount of carbon dioxide without the need to precisely control the level of carbon dioxide present in the exiting gas stream, such as in the case of the test and measurement applications. Thus, the vessel 36 containing the sodium bicarbonate solution may simply be open to the environment to be enriched in carbon dioxide. In such applications, approximately one gram of baking soda is capable of producing about 0.25 grams of carbon dioxide, or about 0.012 mol CO₂.

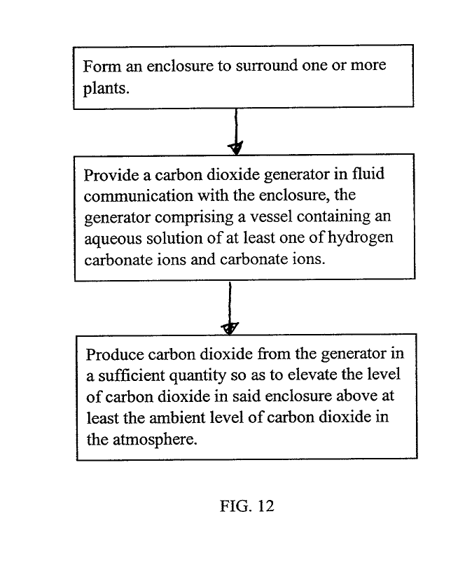

FIG. 12 shows a flow chart for a method of enriching the carbon dioxide content of a plant culturing environment using the carbon dioxide generators of the present invention. First, an enclosure is formed to surround one or more plants. The enclosure may vary in size from relatively small so as to enclose only a single plant, or may be a larger structure such as a greenhouse. The enclosure should be sufficiently sealed so as to allow elevated levels of carbon dioxide to build up within the enclosure. Nevertheless, it is to be understood as in any conventional greenhouse, that the enclosure may be somewhat leaky with respect to the outside environment.

A carbon dioxide generator is provided which is in fluid communication with the enclosure. The carbon dioxide generator may be either inside the enclosure, or may be located elsewhere but connected to the enclosure through a gas line. The carbon dioxide generator may be any of the generators described above, such as those illustrated in FIGS. 2-9. Preferably, the generator is capable of producing large amounts of carbon dioxide for a sustained period of time, and thus the generators illustrated in FIGS. 2-3 are preferred.

The generator is operated so as to produce carbon dioxide in a sufficient quantity so as to elevate the level of carbon dioxide within the enclosure. The atmospheric concentration of carbon dioxide is about 360 ppm. It is desired to operate the carbon dioxide generators so as to elevate the carbon dioxide level in the enclosure from about 360 to about 2000 ppm or even higher, such as 4000 ppm. In addition, it is desired to sustain these elevated concentrations over a period of time, or at least one hour and preferably from two to three hours or even longer.

The generators shown in FIGS. 2-3 are particularly suited to use in connection with elevating the carbon dioxide content in a plant culturing environment. In these applications, large amounts of sodium bicarbonate may be added to a loading section 38 to provide a relatively continuous source of hydrogen carbonate ions and carbonate ions in the aqueous solution 37. The rate at which water flows through the loading section 38 and the agitation section 40 may be controlled together with the degree of agitation so as to produce large amounts of carbon dioxide and yet react as much of the carbonate ions and hydrogen carbonate ions in the aqueous solution 37 as possible. Waste products which drain from the agitation section 40 may be used to water the plants within the enclosure. While it is desired to elevate the level of carbon dioxide within the enclosure, it is not necessary to produce an anaerobic environment.

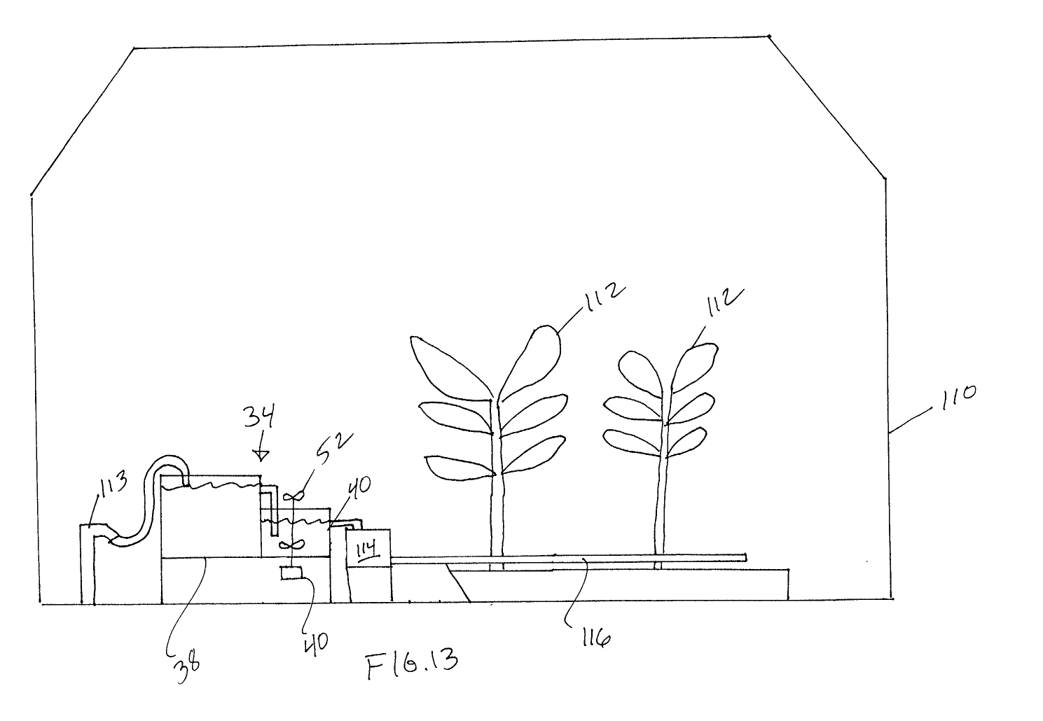

FIG. 13 shows an exemplary embodiment of one such application. A greenhouse 110 encloses several plants 172. A water source 113 flows water into the loading section 38 of a carbon dioxide generator 34b. An agitator 48 stirs the aqueous solution 37, which produced carbon dioxide. The carbon dioxide is blown into the greenhouse by fan 52. The waste products flow into a tank 114, which may buffer the solution or otherwise modify the pH, remove salt, and/or add additional optional nutrients. The water then flows along pipe 116 to water the plants 112.

Alternatively, the level of carbon dioxide gas in a plant culturing environment may be enriched without the use of an enclosure. For example, in locations where the air is sufficiently still, the carbon dioxide level in the area around the plant culturing environment may be increased by using a carbon dioxide generator placed in the plant culturing environment. Thus, for example, the carbon dioxide generators 34 of the present invention may be placed in an orchard or other plant growing environment to enhance the level of carbon dioxide locally.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. An apparatus for providing carbon dioxide to a plant, comprising:
(a) a chamber adapted to enclose at least a portion of said plant;
(b) a gas source capable of providing gas substantially free of carbon dioxide; and
(c) a carbon dioxide generator in fluid communication with said chamber and said gas source, said generator comprising a vessel containing an aqueous solution of at least one of hydrogen carbonate ions and carbonate ions.

2. The apparatus of claim 1 wherein said generator further comprises an agitator capable of agitating said solution.

3. The apparatus of claim 2 wherein said agitator is an inlet to said vessel in fluid communication with said gas source.

4. The apparatus of claim 1 wherein said generator further comprises a fan.

5. The apparatus of claim 1 wherein said generator has a loading section for addition of a solid source of at least one of hydrogen carbonate ions and carbonate ions.

6. The apparatus of claim 1 wherein said chamber has a carbon dioxide content of from 0 to 4000 ppm.

7. The apparatus of claim 1 wherein said generator further comprises a source of acid.

8. A method for providing carbon dioxide to a plant, comprising:
(a) forming a chamber and enclosing at least a portion of said plant with said chamber;
(b) providing a gas source capable of providing a first gas substantially free of carbon dioxide;
(c) providing a carbon dioxide generator in fluid communication with said chamber and said gas source, said generator comprising a vessel containing an aqueous solution of at least one of hydrogen carbonate ions and carbonate ions;
(d) producing carbon dioxide from said aqueous solution; and
(e) mixing said carbon dioxide with said first gas to produce a gas mixture having a level of carbon dioxide and flowing said gas mixture into said chamber.

9. The method of claim 8, further comprising the step of agitating said solution to produce said carbon dioxide.

10. The method of claim 9 wherein said step of agitating said solution comprises flowing said first gas through said aqueous solution.

11. The method of claim 8, further comprising the step of adding an acid to said solution to produce said carbon dioxide.

12. The method of claim 8 wherein said generator further comprises a fan.

13. The method of claim 8, further comprising the step of adding a solid source of at least one of hydrogen carbonate ions and carbonate ions to said generator.

14. The method of claim 8 wherein said chamber has a carbon dioxide content of from 0 to 4000 ppm.

15. A method for providing an elevated level of carbon dioxide to a plant culturing environment, comprising:
(a) forming an enclosure to surround said plant;
(b) providing a carbon dioxide generator in fluid communication with said enclosure, said generator comprising a vessel containing an aqueous solution of at least one of hydrogen carbonate ions and carbonate ions; and
(c) producing carbon dioxide from said solution in a sufficient quantity so as to elevate the level of carbon dioxide in said enclosure above ambient level.

16. The method of claim 15, further comprising the step of agitating said solution to produce said carbon dioxide.

17. The method of claim 16 wherein said step of agitating said solution comprises flowing a gas through said aqueous solution.

18. The method of claim 15, further comprising the step of adding an acid to said solution to produce said carbon dioxide.

19. The method of claim 15 wherein said generator further comprises a fan.

20. The method of claim 15, further comprising the step of adding a solid source of at least one of hydrogen carbonate ions and carbonate ions to said generator.

21. The method of claim 15, further comprising the step of flowing said aqueous solution through said vessel.

22. The method of claim 15 wherein said enclosure is a greenhouse.

23. A method for providing carbon dioxide to an environment, comprising:
(a) placing a carbon dioxide generator in said environment, said generator comprising a vessel containing an aqueous solution of at least one of hydrogen carbonate ions and carbonate ions;
(b) agitating said solution to produce carbon dioxide, wherein said carbon dioxide is produced without addition of acid to said aqueous solution; and
(c) producing carbon dioxide from said aqueous solution in a sufficient quantity so as to elevate the level of carbon dioxide in said environment.

24. The method of claim 23 wherein said step of agitating said solution comprises flowing a gas through said aqueous solution.

25. The method of claim 23 wherein said generator further comprises a fan.

26. The method of claim 23, further comprising the step of adding a solid source of at least one of hydrogen carbonate ions and carbonate ions to said generator.

27. The method of claim 23, further comprising the step of flowing said aqueous solution through said vessel.

28. The method of claim 23 wherein said environment is a plant culturing environment.

29. An apparatus for providing carbon dioxide, comprising:
(a) a vessel containing an aqueous solution of at least one of hydrogen carbonate ions and carbonate ions, said vessel comprising an agitation section;
(b) an agitator adapted to agitate said solution;
(c) a water source in fluid communication with said vessel for supplying water to said vessel; and
(d) said vessel having a drain to allow said aqueous solution to flow out of said vessel.

30. The apparatus of claim 29, further comprising a loading section.

31. An apparatus for generating carbon dioxide, comprising:
(a) a chamber;
(b) a carbon dioxide generator in fluid communication with said chamber, said generator comprising a first section containing an aqueous solution of at least one of hydrogen carbonate ions and carbonate ions and a second section containing an acidic solution; and
(c) a wick disposed between said first section and said second section.
